(19) United States
(12) Patent Application Publication
(10) Pub. No.: US 2022/0079400 A1
(43) Pub. Date: Mar. 17, 2022

(54) SURFACE CLEANING ROBOT

(71) Applicant: ECOVACS ROBOTICS CO., LTD., Suzhou (CN)

(72) Inventors: Shoumu WANG, Suzhou (CN); Jianfeng HU, Suzhou (CN)

(73) Assignee: ECOVACS ROBOTICS CO., LTD., Suzhou (CN)

(21) Appl. No.: 17/424,874

(22) PCT Filed: Dec. 19, 2019
(86) PCT No.: PCT/CN2019/126667

§ 371 Date: Jul. 21, 2021

(30) Foreign Application Priority Data
Jan. 21, 2019 (CN) 201910053478.3

(51) Int. Cl. A47L 1/02; B08B 1/00; B08B 1/04

(52) U.S. Cl. CPC A47L 1/02; B08B 1/006; A47L 2201/00; B08B 1/04; B08B 1/008

(57) ABSTRACT

A surface cleaning robot includes: a first cleaning unit arranged at a bottom of a main body; and a second cleaning unit arranged on one side of the main body. The second cleaning unit rotates under the action of a drive mechanism. Compared with the prior art, the surface cleaning robot cleans, by means of the second cleaning unit on one side of the main body, a surface to be cleaned. The driving of the second cleaning unit is independent from the walking of the surface cleaning robot, which is different from the prior art where bottom cleaning is performed while the surface cleaning robot walks. Therefore, rollers having a large volume are omitted. By driving the second cleaning unit to rotate, the cleaning effect is better improved.

### FIELD

The present disclosure relates to the field of robots, and more particularly relates to a surface cleaning robot.

### BACKGROUND

In daily life, people generally use wiping cloths to clean and scrub glass. After a long period of glass cleaning, arms may get tired. Robots capable of performing window wiping are known in the prior art. A window cleaning robot is firmly attached to glass mainly by means of a vacuum pump or a blower device at the bottom of the window cleaning robot. Dirt on the glass is then wiped off with a wiping cloth at the bottom of a body by utilizing the force of the window cleaning robot adsorbed on the glass.

For example, Chinese patent document CN10630872A discloses a window wiping robot device. In the device, a wiping cloth for wiping a window is arranged at the bottom of a surface cleaning robot, and the wiping cloth is driven to rotate by two rollers at the bottom of the surface cleaning robot to clean the window. However, due to the large size of the rollers, the edges of the wiping cloth are likely to warp and cannot be adhered to the corners of the glass, leaving a dead space for wiping the window.

### SUMMARY

The present disclosure provides a surface cleaning robot for solving the technical problem of poor glass corner cleaning effect of a robot in the prior art.

The present disclosure provides a surface cleaning robot, having a main body, including:

a first cleaning unit arranged at a bottom of the main body; and

a second cleaning unit arranged on one side of the main body, where the second cleaning unit rotates under an action of a drive mechanism.

Alternatively, the bottom of the main body is provided with a negative pressure chamber, and the first cleaning unit is arranged around a periphery of the negative pressure chamber.

Alternatively, the second cleaning unit is located at a front end of the main body by taking a traveling direction of the surface cleaning robot as a forward direction.

Alternatively, a rotation direction of the second cleaning unit is parallel or perpendicular to the traveling direction of the cleaning robot.

Alternatively, when the rotation direction of the second cleaning unit is perpendicular to the traveling direction of the surface cleaning robot, the drive mechanism includes: a driving wheel and two driven wheels. The diameter of the driving wheel is greater than the diameter of the driven wheels, the driven wheels are arranged nearby the bottom of the main body and are respectively located at two ends of an end face where the second cleaning unit is located, and the axes of the driving wheel and the driven wheels are parallel to the traveling direction of the surface cleaning robot.

Alternatively, the driven wheel has an outer diameter of not more than 8 mm.

Alternatively, the surface of the driven wheel is a smooth surface or a geared surface.

Alternatively, the drive mechanism further includes: a drive motor and a work belt.

The work belt is sleeved outside the driving wheel and the two driven wheels.

The second cleaning unit is arranged on the work belt, the work belt is driven to rotate by the drive motor, and the second cleaning unit is driven to move against a surface to be cleaned, so as to clean the surface to be cleaned.

Alternatively, the surface cleaning robot further includes: one or more tension pulleys arranged between the driving wheel and the driven wheel and abutting against the outer side of the work belt.

Alternatively, when the rotation direction of the second cleaning unit is parallel to the traveling direction of the surface cleaning robot, the drive mechanism includes a driving wheel. The axis of the driving wheel is perpendicular to the traveling direction of the surface cleaning robot, and one end of the second cleaning unit is sleeved on the driving wheel.

Correspondingly, the surface robot further includes a bottom plate. The bottom plate is arranged under the driving wheel, and two side edges of the bottom plate respectively abut against the inner side of the second cleaning unit, so that the second cleaning unit forms an included angle between the bottom plate and the driving wheel.

Alternatively, the included angle is in the range of 15-60°.

Alternatively, the drive mechanism further includes: a drive motor and a work belt.

A gap is provided between the bottom plate and the main body for the work belt to rotate, and the work belt is sleeved outside the driving wheel and the bottom plate.

The second cleaning unit is arranged on the work belt, the work belt is driven to rotate by the drive motor, and the second cleaning unit is driven to move against a surface to be cleaned, so as to clean the surface to be cleaned.

Alternatively, the bottom plate is provided with a bracket, and the bracket divides the bottom plate into a first portion, a middle portion, and a second portion.

The drive motor is arranged in the first portion, the middle portion, or the second portion.

Alternatively, when the drive motor is arranged in the middle portion, the work belt is sleeved outside a portion of the driving wheel above the first portion and the first portion, and outside a portion of the driving wheel above the second portion and the second portion, respectively.

Alternatively, the work belt is provided with an adhesive member by which the second cleaning unit is adhered to the work belt.

Alternatively, the surface cleaning robot further includes a reduction mechanism. The reduction mechanism is arranged on the body, an input end of the reduction mechanism is connected to an output shaft of the drive motor, an output end of the reduction mechanism drives the driving wheel to rotate, and the reduction mechanism is configured to match an output rotational speed of the drive motor to a required rotational speed of the work belt.

Alternatively, the reduction mechanism includes a reduction gearbox and a synchronous belt. The drive motor drives the driving wheel to rotate through the reduction gearbox and the synchronous belt.

The present disclosure further provides a surface cleaning robot, having a main body. The surface cleaning robot includes: a side cleaning mechanism arranged on a side face of the main body. The side cleaning mechanism includes a drive mechanism and a cleaning unit, and the cleaning unit rotates under the action of the drive mechanism to perform cleaning work against a surface to be cleaned.

Alternatively, the drive mechanism includes a drive motor and a work belt. The cleaning unit is sleeved on the work belt, and a rotation direction of the work belt is parallel or perpendicular to the side face of the main body where the side cleaning mechanism is located.

Alternatively, a surface edge where the cleaning unit is in contact with the surface to be cleaned is supported to have an edge angle of not more than 90°, and the edge angle is positioned flush with or beyond the side face of the main body.

The present disclosure also provides a surface cleaning robot having a main body, including:

a first cleaning unit, arranged around the periphery of a negative pressure chamber at the bottom of the main body; and

a second cleaning unit, located outside or inside the first cleaning unit, where the second cleaning unit rotates under the action of a drive mechanism.

Compared with the prior art, one or more technical solutions provided by the embodiments of the present disclosure have at least the following advantages:

the embodiments of the present disclosure provide a surface cleaning robot having a main body, including: a first cleaning unit arranged at the bottom of the main body; and a second cleaning unit arranged on one side of the main body, where the second cleaning unit rotates under the action of a drive mechanism.

Compared with the prior art, the surface cleaning robot provided by the present disclosure cleans, by means of the second cleaning unit on one side of the main body, a surface to be cleaned. The driving of the second cleaning unit is independent from the walking of the surface cleaning robot, which is different from the prior art where bottom cleaning is performed while the surface cleaning robot walks. Therefore, rollers having a large volume are omitted. By driving the second cleaning unit to rotate, the area of a wiping cloth is increased, the dust holding rate of the wiping cloth is improved, and the cleaning effect is better improved.

### BRIEF DESCRIPTION OF THE DRAWINGS

FIG. 1 is a front view of a surface cleaning robot provided in Embodiment 1 of the present disclosure;

FIG. 2 is a bottom view of a surface cleaning robot provided in Embodiment 1 of the present disclosure;

FIG. 3 is a schematic structure view of a drive mechanism without a cover plate provided in Embodiment 1 of the present disclosure;

FIG. 4 is a schematic structure view of a drive mechanism with a cover plate provided in Embodiment 1 of the present disclosure;

FIG. 5 is a schematic structure view of a drive motor provided in Embodiment 1 of the present disclosure;

FIG. 6 is an exploded schematic view of a second cleaning unit adhered to a work belt provided in Embodiment 1 of the present disclosure;

FIG. 7 is a front view of a surface cleaning robot provided in Embodiment 2 of the present disclosure;

FIG. 8 is a bottom view of a surface cleaning robot provided in Embodiment 2 of the present disclosure;

FIG. 9 is a front view of a drive mechanism without a second cleaning unit provided in Embodiment 2 of the present disclosure;

FIG. 10 is a side view of a drive mechanism provided in Embodiment 2 of the present disclosure;

FIG. 11 is an exploded schematic view of a second cleaning unit adhered to a work belt provided in Embodiment 2 of the present disclosure; and

FIG. 12 is a schematic view of an edge angle of a cleaning unit provided in Embodiment 3 of the present disclosure.

### DETAILED DESCRIPTION OF EXAMPLE EMBODIMENTS

In the following description, many specific details are set forth in order to fully understand the present disclosure. However, the present disclosure can be implemented in many other ways different from those described herein, and those skilled in the art can make similar promotion without violating the connotation of the present disclosure. Therefore, the present disclosure is not limited by the specific embodiments disclosed below.

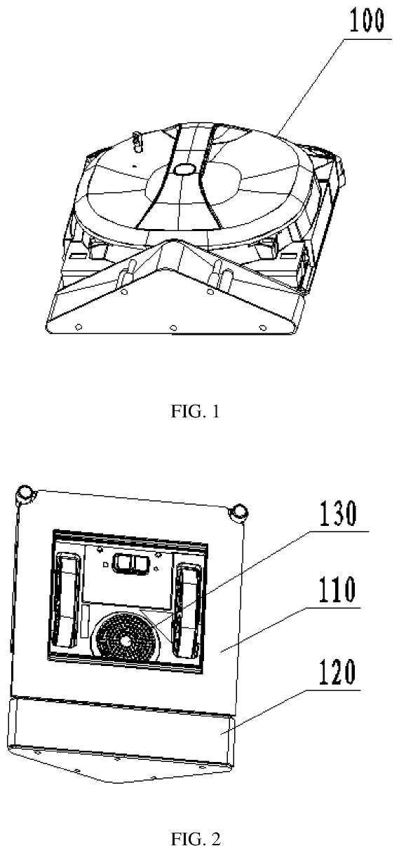

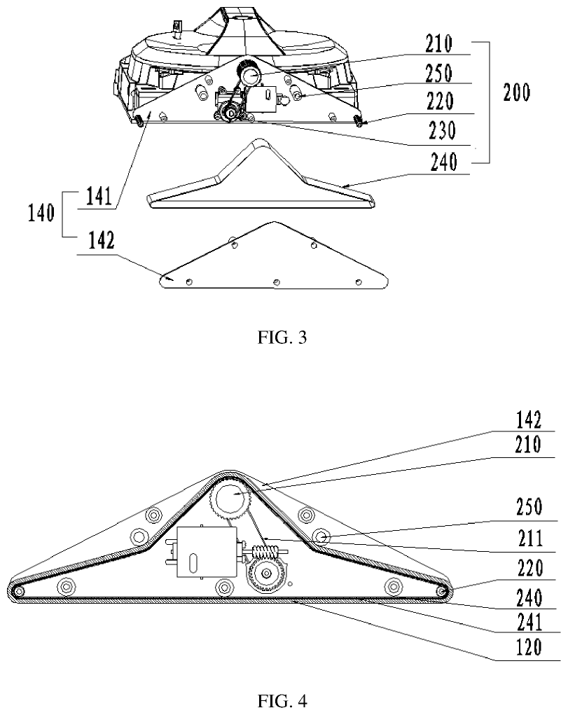

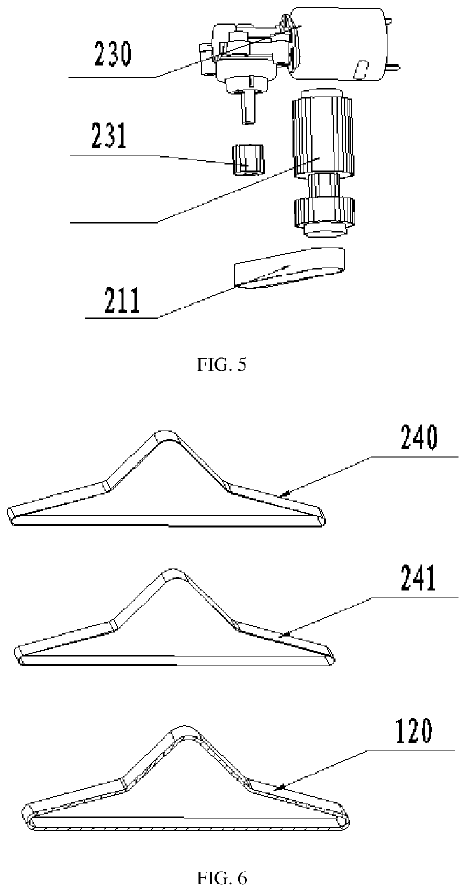

FIGS. 1-6 show a surface cleaning robot provided by a first embodiment of the present disclosure.

The embodiments of the present disclosure provide a surface cleaning robot having a main body 100, including:

a first cleaning unit 110, arranged at the bottom of the main body 100; and

a second cleaning unit 120, arranged on one side of the main body 100, where the second cleaning unit 120 rotates under the action of a drive mechanism 200.

The main body 100 has a square shape as a whole, and is connected with an external power line (not shown in the drawings) to work. Of course, the surface cleaning robot may also be internally provided with a rechargeable battery and may be powered by the battery to work. Or, the surface cleaning robot may be provided with an external power supply and a rechargeable battery and may work in both cases.

The top of the main body 100 is a hand-held portion that is convenient for a user to hold, so as to place the surface cleaning robot into a work position. The bottom of the main body 100 is provided with a negative pressure chamber, and the first cleaning unit 110 is arranged around the periphery of the negative pressure chamber.

The bottom of the main body 100 is provided with a suction member 130. The suction member 130 may be a vacuum cup or a fan. Its principle is to suck on the glass by forming a pressure difference between the inner side and outer side of the main body 100. Of course, the vacuum cup usually sucks on a glass surface since forming a certain vacuum environment requires a flat sucking media surface without obstacles. A fan may suck on a marble wall surface, a ceramic tile surface, etc. in addition to a glass surface.

The bottom of the main body 100 is also provided with a roller. When cleaning glass, the surface cleaning robot moves on the glass surface along a planned window wiping path (e.g. in a wiping sequence from left to right and from top to bottom), and drives the first cleaning unit 110 to wipe a large area of dirt on the glass by utilizing the force of the suction member 130 sucking on the glass.

In order to better remove the dirt at glass corners, the surface cleaning robot provided by the embodiments of the present disclosure is provided with a second cleaning unit 120 in addition to the first cleaning unit 110 at the bottom of the main body 100. Specifically, the second cleaning unit is located at a front end of the main body by taking a traveling direction of the surface cleaning robot as a forward direction, and is driven by the drive mechanism 200 to improve the wiping of the hard-to-clean corners by the surface cleaning robot. The drive mechanism 200 is described in detail below.

The drive mechanism 200 includes: a driving wheel 210 and two driven wheels 220. The diameter of the driving wheel 210 is greater than the diameter of the driven wheels 220. The driven wheels 210 are arranged nearby the bottom of the main body 100 and are respectively located at two ends of an end face where the second cleaning unit 120 is located. The axes of the driving wheel 210 and the driven wheels 220 are parallel to the traveling direction of the surface cleaning robot.

In the present embodiment, the drive mechanism 200 further includes: a drive motor 230 and a work belt 240.

The work belt 240 is sleeved outside the driving wheel 210 and the two driven wheels 220, the driving wheel 210 is driven to rotate by the drive motor 230, and the driving wheel 210 drives the work belt 240 to rotate along the outer sides of the driving wheel 210 and the two driven wheels 220.

The second cleaning unit 120 is arranged on the work belt 240. Specifically, the work belt 240 is provided with an adhesive member 241. The second cleaning unit 120 is adhered to the work belt 240 by the adhesive member 241. Alternatively, the adhesive member 241 is a magic sticker.

Since the work belt 240 is sleeved outside the driving wheel 210 and the two driven wheels 220, when the work belt 240 rotates, the rotation direction of the second cleaning unit 120 is perpendicular to the traveling direction of the cleaning robot. When the surface cleaning robot wipes corners of a surface to be cleaned, the rotation direction of the second cleaning unit 120 arranged on the work belt 240 is not limited by the traveling direction of the surface cleaning robot. Thus, the defect that a warping edge cannot be well adhered to the surface to be cleaned since the second cleaning unit 120 is affected by the rollers of the surface cleaning robot is avoided.

When the surface cleaning robot travels, the second cleaning unit 120 moves against the surface to be cleaned. By means of the suction force between the surface cleaning robot and the surface to be cleaned, the second cleaning unit 120 is driven by the working belt 240 to form rolling friction with the surface to be cleaned, so as to remove the dirt on the surface to be cleaned.

Specifically, the drive mechanism 200 is mounted on a body 140. The body 140 is arranged against a side face of the main body 100, and the body 140 includes: a motor base 141 for mounting the drive motor 230, and a cover plate 142. The motor base 141 and the cover plate 142 are fixed to each other. A variety of schemes may be used for a specific fixing mode. For example, the cover plate 142 is provided with a protruding portion, a fixing portion is arranged at a corresponding position of the motor base 141 in cooperation with the protruding portion, and the motor base 141 and the cover plate 142 are fixedly connected by fitting the protruding portion onto the fixing portion. Of course, the arrangement of the protruding portion and the fixing portion may be interchanged, i.e. the protruding portion may be arranged on the motor base 141 and the fixing portion may be arranged on the cover plate 142, which does not affect the cooperation therebetween.

The drive motor 230 is fixedly arranged on the motor base 141. The drive motor 230 is configured to convert electric energy into rotary power. There are many options in the prior art. Specifically, an appropriate motor may be selected in combination with an output rotational speed and an output torque required by the window cleaning operation of the surface cleaning robot, and according to factors such as a power supply (direct current or alternating current mains supplied by a battery) used. Many motors are alternative in the prior art, and descriptions are omitted herein.

When the drive motor 230 is arranged, a screw hole may be provided on the side face of the main body 100. A screw passes through the motor base 141 and then is fixed in the screw hole, so that the drive motor 230 is fixed on the side face of the main body 100. In this way, the motor base 141 may be fixed on the side face of the main body 100. Alternatively, the drive motor 230 may be fixed to the motor base 141, and then the motor base 141 may be fixedly arranged on the side face of the main body 100.

Specifically, the motor base 141 may be a triangular flat plate which is arranged against the side face of the main body 100. Specifically, at least one of the four side faces of the main body 100 is a flat side face or at least one side face is a partially flat side face. The drive motor 230 is fixedly arranged at a contact position between the triangular flat plate and a flat portion of the side face. When fixing, one of the bottom edges of the triangular flat plate is aligned with the bottom of the main body 100 so that the second cleaning unit 120 can be arranged in a direction perpendicular to the side face of the main body 100. After fixing, the cover plate 142 is fastened to the motor base 141 to be assembled into the complete body 110.

The drive mechanism 200 is arranged between the motor base 141 and the cover plate 142, and the driving wheel 210 and the two driven wheels 220 are arranged on the motor base 141. An output shaft of the drive motor 230 outputs through a reduction gearbox, and is connected to a motor pulley 231 through a worm gear pair. The specific structure is that the drive motor 230 is directly connected to the worm through an output shaft of the reduction gearbox, and the motor pulley 231 is arranged coaxially with the worm gear. The motor pulley 231 is connected to the driving wheel 210 through a synchronous belt 211. By means of the synchronous belt 211, the rotation of the motor pulley 231 can drive the driving wheel 210 to rotate, and the rotation of the driving wheel 210 drives the work belt 240 to rotate. A motion transmission mechanism composed of the reduction gearbox, a worm gear mechanism, the synchronous belt 211, etc. may be regarded as a complete reduction mechanism for matching an output rotational speed of the drive motor 230 to a required rotational speed of the work belt 240.

In an alternative embodiment, the driven wheel 220 has an outer diameter of not more than 8 mm. As the outer diameter of the driven wheel 220 is smaller, it is easier for the second cleaning unit 120 sleeved outside the driven wheel 220 to be in contact with the corner of the surface to be cleaned, thereby improving the cleaning effect.

The surface of the driven wheel 220 may be a smooth surface or a geared surface. Specifically, the driven wheel 220 may be a gear that meshes with the work belt 240. For example, the number of teeth of the driven wheel 220 is 8-15, and the pitch diameter is less than 7 mm. The driven wheel 220 may also be an optical axis. For example, an optical axis having a diameter of less than 6 mm is used.

In an alternative embodiment, the drive mechanism 200 further includes: one or more tension pulleys 250. The tension pulleys 250 are arranged between the driving wheel 210 and the driven wheel 220 and abut against the outer side of the work belt 240. By arranging the tension pulley 250 to maintain a certain tension of the second cleaning unit 120 during rotation, it is possible to more effectively maintain the rotation of the work belt 240, to avoid slipping during transmission, and to form rolling friction between the work belt 240 and the surface to be cleaned, thereby improving the cleaning effect.

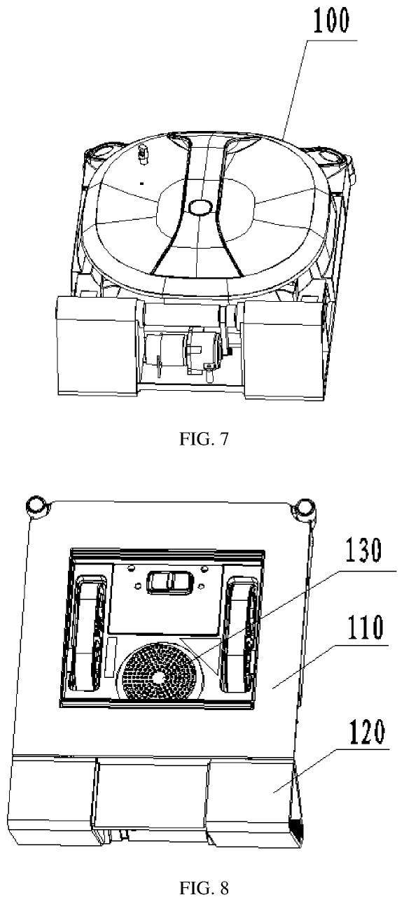

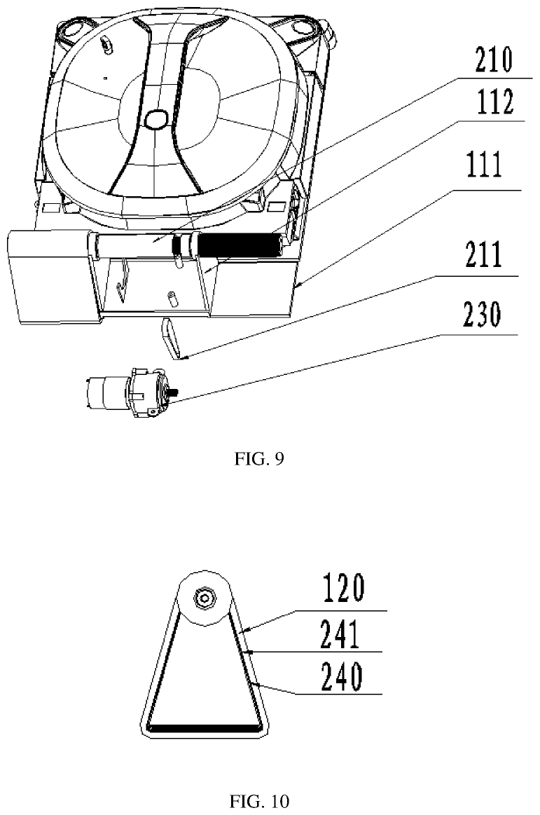

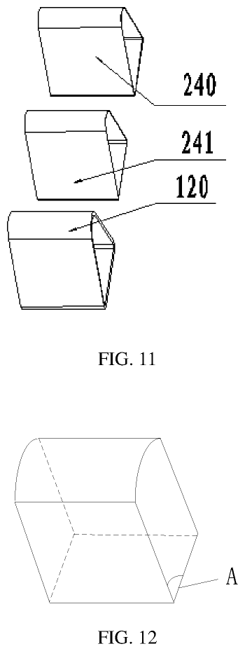

FIGS. 7-11 show an arrangement mode of a drive mechanism 200 according to a second embodiment of the present disclosure. The arrangement mode is characterized in that the rotation direction of the work belt is parallel to the traveling direction of the surface cleaning robot. The arrangement mode is described in more detail below. In the present second embodiment, the same parts as those in the first embodiment are identified by the same icons.

The drive mechanism 200 includes a driving wheel 210. The axis of the driving wheel 210 is perpendicular to the traveling direction of the surface cleaning robot. One end of the second cleaning unit 120 is sleeved on the driving wheel 210.

Correspondingly, the surface robot further includes a bottom plate 111 for placing the drive motor 230. The bottom plate 111 is arranged under the driving wheel 210, and two side edges of the bottom plate 111 respectively abut against the inner side of the second cleaning unit 120, so that the second cleaning unit 120 forms an included angle between the bottom plate 111 and the driving wheel 210. Specifically, the included angle is in the range of 15-60°. As the included angle is smaller, it is easier for the second cleaning unit 120 sleeved between the bottom plate 111 and the driving wheel 21 to be in contact with the corner of the surface to be cleaned, thereby improving the cleaning effect.

In the present embodiment, the drive mechanism 200 further includes: a drive motor 230 and a work belt 240.

A gap is provided between the bottom plate 111 and the main body 100 for the work belt 240 to move therein, so that the work belt 240 is sleeved outside the driving wheel 210 and the bottom plate 111 of the main body 110.

The second cleaning unit 120 is arranged on the work belt 240. Specifically, the work belt 240 is provided with an adhesive member 241. The second cleaning unit 120 is adhered to the work belt 240 by the adhesive member 241. Alternatively, the adhesive member 241 is a magic sticker.

Since the work belt 240 is sleeved outside the driving wheel 210 and the bottom plate 111 of the main body 110, when the work belt 240 rotates, the rotation direction of the second cleaning unit 120 is parallel to the traveling direction of the cleaning robot. When the surface cleaning robot wipes corners of a surface to be cleaned, the rotation direction of the second cleaning unit 120 arranged on the work belt 240 is not limited by the traveling direction of the surface cleaning robot. Thus, the defect that a warping edge cannot be well adhered to the surface to be cleaned since the second cleaning unit 120 is affected by the rollers of the surface cleaning robot is avoided.

When the surface cleaning robot travels, the second cleaning unit 120 moves against the surface to be cleaned. By means of the suction force between the surface cleaning robot and the surface to be cleaned, the second cleaning unit 120 is driven by the working belt 240 to form rolling friction with the surface to be cleaned, so as to remove the dirt on the surface to be cleaned.

Specifically, the drive mechanism 200 is placed on a side face of the main body 100 through the bottom plate 111 where the drive motor 230 is placed. The bottom plate 111 is a bottom plate 111 formed by lateral extension of the bottom plate 111 of the main body 100. The bottom plate 111 is provided with a bracket 112. The bracket 112 divides the bottom plate 111 into a first portion, a middle portion, and a second portion. The drive motor 230 is arranged in the first portion, the middle portion, or the second portion.

After the position of the drive motor 230 is fixed, if the drive motor 230 is fixed to the first portion, a gap exists between portions of the bottom plate 111 corresponding to the middle portion and the second portion and the main body 100, and the distance of the gap is sufficient for the work belt 240 to move therein. If the drive motor 230 is arranged in the middle portion or the second portion, a gap for the work belt 240 to move therein remains, and descriptions are omitted herein.

The bottom plate 111 of the first portion where the drive motor 230 is located may be fixed to the main body 100 in a detachable connection manner, and may be directly fixed to a side plate of the surface cleaning robot or fixed to a side wall of the bottom plate 111 of the surface cleaning robot.

The bracket 112 is two flat plates arranged in parallel, a semicircular opening is provided at the top of the flat plate, and the whole is in a regular triangle shape. The driving wheel 210 is arranged on the semicircular opening of the bracket 112. The driving wheel 210 is arranged on the bracket 112.

Alternatively, the length of the driving wheel 210 is adapted to the length of the bottom plate 111, and the length of the driving wheel 210 and the length of the bottom plate 111 are also adapted to the length of the side plate of the main body 100, so that the surface cleaning robot is not be obstructed by the length of a side cleaning structure 100 when traveling.

When the drive motor 230 is arranged, a motor bracket for fixing the drive motor 230 is arranged on the bottom plate 111. The height of the motor bracket is lower than the height of the bracket 112, so that after the driving wheel 210 is arranged on the bracket 112, there is sufficient space for arranging the drive motor 230 between the driving wheel 210 and the bottom plate 111 of the body 110. An output shaft of the drive motor 230 is connected to a reduction gearbox of a reduction mechanism. An output shaft of the reduction gearbox is connected to the driving wheel 210 through a synchronous belt 211. By means of the synchronous belt 211, the rotation of the drive motor 230 can drive the driving wheel 210 to rotate, and the rotation of the driving wheel 210 can drive the work belt 240 to rotate. The reduction gearbox and the synchronous belt 211 form a reduction mechanism of the drive motor 230 for matching an output rotational speed of the drive motor 230 to a required rotational speed of the work belt 240.

In an alternative embodiment, the drive motor 230 is arranged in the middle portion, and the work belt 240 is sleeved outside a portion of the driving wheel 210 above the first portion and the first portion, and outside a portion of the driving wheel 210 above the second portion and the second portion, respectively.

The present disclosure also provides a surface cleaning robot as a third embodiment of the present disclosure. In the third embodiment of the present disclosure, the same parts as the first embodiment and the second embodiment of the present disclosure are not described in detail herein. The surface cleaning robot provided by the third embodiment of the present disclosure has a main body. The surface cleaning robot includes: a side cleaning mechanism arranged on a side face of the main body. The side cleaning mechanism includes a drive mechanism and a cleaning unit, and the cleaning unit rotates under the action of the drive mechanism to perform cleaning work against a surface to be cleaned.

The drive mechanism includes a drive motor and a work belt. The cleaning unit is sleeved on the work belt, and a rotation direction of the work belt is parallel or perpendicular to the side face of the main body where the side cleaning mechanism is located. The specific arrangement can be seen in the first embodiment and the second embodiment of the present disclosure.

A surface edge where the cleaning unit is in contact with the surface to be cleaned is supported to have an edge angle of not more than 90° (or an included angle), and the edge angle is positioned flush with or beyond the side face of the main body. The edge angle means an angle inside the cleaning unit at a folded position when a flat cleaning unit is folded into a three-dimensional shape. For example, when the cleaning unit is sleeved in a work belt, e.g. a triangular work belt has three acute angles, the three acute angles may be regarded as the edge angles of the work belt, after the cleaning unit is arranged on the work belt, the cleaning unit has three acute angles which are regarded as the edge angles of the cleaning unit.

Referring to FIG. 12, in the present embodiment, the cleaning unit has a rectangular parallelepiped shape as a whole, and the edge angle A is 90°. The edges of the edge angle A are respectively a first edge and a second edge which are perpendicular to each other. When the cleaning unit sweeps two sides of a glass right angle, the position of the edge angle A is flush with or beyond the side face of the main body, and the first edge and the second edge of the cleaning unit can better fit with both sides of the glass right angle, so that the cleaning unit can be driven by the drive mechanism to better clean the glass right angle. As an alternative, the cleaning unit as a whole may also be cubic.

In addition, the edge angle may also be an edge angle of less than 90°. Referring to FIG. 4, the second cleaning unit 120 is cubic as a whole under the support of the driving wheel 210 and the two driven wheels 220. The second cleaning unit 120 has an edge angle of less than 90° around the edge portions of the two driven wheels. Further, the second cleaning unit 120 on both sides of the driving wheel 210 has an edge angle of more than 90° under the action of the tension pulley 250.

Specifically, an edge angle portion, less than 90°, of the second cleaning unit 120 near the edge of the cover plate 142 may extend partially out of the cover plate 142 or may be at least flush with the cover plate 142. In summary, the edge angle portion, less than 90°, of the second cleaning unit 120 can be in contact with the glass right angle or the corner portion of the surface to be cleaned. When cleaning, the surface cleaning robot is close to the glass right angle, an edge angle edge, less than 90°, of the second cleaning unit 120 is close to the corner portion of the glass right angle. The second cleaning unit 120 cleans the corner part of the glass right angle under the driving of the drive motor 230 until the cleaning work is completed.

The present disclosure also provides a surface cleaning robot having a main body, including:

a first cleaning unit, arranged around the periphery of a negative pressure chamber at the bottom of the main body; and

a second cleaning unit, located outside or inside the first cleaning unit, where the second cleaning unit rotates under the action of a drive mechanism.

In the embodiments of the present disclosure, the surface to be cleaned is cleaned by arranging a side cleaning mechanism. Since the driving of a side cleaning member is independent from the walking of a window cleaning robot, which is different from the prior art where bottom cleaning is performed while the window cleaning robot walks. Therefore, rollers having a large volume are omitted. By adopting the structure, the robot can better fit a surface to be cleaned, in particular, corners of glass, thereby obviously improving the cleaning effect.

The present disclosure is disclosed as above with the preferred embodiments, but is not limited thereto. Any person skilled in the art can make possible changes and modifications without departing from the spirit and scope of the present disclosure. Therefore, the protection scope of the present disclosure shall be subject to the scope defined by the claims of the present disclosure.

1. A surface cleaning robot, having a main body, comprising:
a first cleaning unit, arranged at a bottom of the main body; and
a second cleaning unit, arranged on one side of the main body, wherein the second cleaning unit rotates under an action of a drive mechanism.

2. The surface cleaning robot according to claim 1, wherein,
the bottom of the main body is provided with a negative pressure chamber, and the first cleaning unit is arranged around a periphery of the negative pressure chamber.

3. The surface cleaning robot according to claim 1, wherein,
the second cleaning unit is located at a front end of the main body by taking a traveling direction of the surface cleaning robot as a forward direction.

4. The surface cleaning robot according to claim 3, wherein,
a rotation direction of the second cleaning unit is parallel or perpendicular to the traveling direction of the cleaning robot.

5. The surface cleaning robot according to claim 4, wherein,
when the rotation direction of the second cleaning unit is perpendicular to the traveling direction of the surface cleaning robot, the drive mechanism comprises:
a driving wheel and two driven wheels, wherein a diameter of the driving wheel is greater than a diameter of the driven wheels;
the driven wheels are arranged nearby the bottom of the main body and are respectively located at two ends of an end face where the second cleaning unit is located; and
axes of the driving wheel and the driven wheels are parallel to the traveling direction of the surface cleaning robot.

6. (canceled)

7. The surface cleaning robot according to claim 5, wherein,
a surface of the driven wheel is a smooth surface or a geared surface.

8. The surface cleaning robot according to claim 5, wherein, the drive mechanism further comprises: a drive motor and a work belt, wherein,
the work belt is sleeved outside the driving wheel and the two driven wheels; and
the second cleaning unit is arranged on the work belt, the work belt is driven to rotate by the drive motor, and the second cleaning unit is driven to move against a surface to be cleaned, so as to clean the surface to be cleaned.

9. The surface cleaning robot according to claim 8, further comprising: one or more tension pulleys, arranged between the driving wheels and the driven wheel and abutting against an outer side of the work belt.

10. The surface cleaning robot according to claim 4, wherein,
when the rotation direction of the second cleaning unit is parallel to the traveling direction of the surface cleaning robot, the drive mechanism comprises:
a driving wheel, wherein an axis of the driving wheel is perpendicular to the traveling direction of the surface cleaning robot, and one end of the second cleaning unit is sleeved on the driving wheel; and
correspondingly, the surface robot further comprises: a bottom plate, wherein the bottom plate is arranged directly beneath the driving wheel, and two side edges of the bottom plate respectively abut against an inner side of the second cleaning unit, so that the second cleaning unit forms an included angle between the bottom plate and the driving wheel.

11. The surface cleaning robot according to claim 10, wherein,
the included angle is in a range of 15-60°.

12. The surface cleaning robot according to claim 10, wherein,
the drive mechanism further comprises: a drive motor and a work belt, wherein,
a gap is provided between the bottom plate and the main body for the work belt to rotate, and the work belt is sleeved outside the driving wheel and the bottom plate; and
the second cleaning unit is arranged on the work belt, the work belt is driven to rotate by the drive motor, and the second cleaning unit is driven to move against a surface to be cleaned, so as to clean the surface to be cleaned.

13. The surface cleaning robot according to claim 10, wherein,
the bottom plate is provided with a bracket, wherein the bracket divides the bottom plate into a first portion, a middle portion, and a second portion; and
the drive mechanism further comprises: a drive motor and a work belt, wherein the drive motor is arranged in the first portion, the middle portion, or the second portion.

14. The surface cleaning robot according to claim 13, wherein,
when the drive motor is arranged in the middle portion, the work belt is sleeved outside a portion of the driving wheel above the first portion and the first portion, and outside a portion of the driving wheel above the second portion and the second portion, respectively.

15. The surface cleaning robot according to claim 1, wherein, the work belt is provided with an adhesive member, the second cleaning unit is adhered to the work belt by the adhesive member.

16. The surface cleaning robot according to claim 8, further comprising: a body arranged on a side face of the main body; and a reduction mechanism, wherein the reduction mechanism is arranged on the body, an input end of the reduction mechanism is connected to an output shaft of the drive motor, an output end of the reduction mechanism drives the driving wheel to rotate, and the reduction mechanism is used to match an output rotational speed of the drive motor to a required rotational speed of the work belt.

17. The surface cleaning robot according to claim 16, wherein, the reduction mechanism comprises: a reduction gearbox and a synchronous belt, the drive motor drives the driving wheel to rotate through the reduction gearbox and the synchronous belt.

18. A surface cleaning robot, having a main body, comprising: a side cleaning mechanism arranged on a side face of the main body, wherein the side cleaning mechanism comprises a drive mechanism and a cleaning unit, and the cleaning unit rotates under an action of the drive mechanism to perform cleaning work against a surface to be cleaned.

19. The surface cleaning robot according to claim 18, wherein, the drive mechanism comprises a drive motor and a work belt, wherein the cleaning unit is sleeved on the work belt, and a rotation direction of the work belt is parallel or perpendicular to the side face of the main body where the side cleaning mechanism is located.

20. The surface cleaning robot according to claim 18, wherein,
a surface edge where the cleaning unit is in contact with the surface to be cleaned is supported to have an edge angle of not more than 90°, and the edge angle is positioned flush with or beyond the side face of the main body.

21. A surface cleaning robot, having a main body, comprising:
a first cleaning unit, arranged around a periphery of a negative pressure chamber at a bottom of the main body; and
a second cleaning unit, located outside or inside the first cleaning unit, wherein the second cleaning unit rotates under the action of a drive mechanism.
